(19) United States
(12) Patent Application Publication
(10) Pub. No.: US 2008/0274383 A1
(43) Pub. Date: Nov. 6, 2008

(54) Process for Fabricating Pressure Vessel Liner

(75) Inventors: Yasuharu Kanno, Oyama-shi (JP); Yasuhiro Osame, Oyama-shi (JP)

Correspondence Address: OBLON, SPIVAK, MCCLELLAND MAIER & NEUSTADT, P.C., 1940 DUKE STREET, ALEXANDRIA, VA, 22314, US

(73) Assignee: Showa Denko K.K., Minato-ku, TOKYO (JP)

(21) Appl. No.: 10/588,314

(22) PCT Filed: Apr. 7, 2005
(86) PCT No.: PCT/JP05/07196

§ 371 Date: Aug. 3, 2006

Related U.S. Application Data
(60) Provisional application No. 60/561,534, filed on Apr. 13, 2004.

(30) Foreign Application Priority Data
Apr. 8, 2004 (JP) 2004-114416

(51) Int. Cl. H01M 8/18; B23K 20/12; F17C 1/02

(52) U.S. Cl. 429/19; 228/112.1; 220/590

(57) ABSTRACT

A process prevents a reduction in the strength of the joint between the liner components, and assures high productivity without impairment. The peripheral walls (6, 7) of the liner component (4) and each of the second liner components (5) are brought into contact with each other, a probe (22) of friction agitation joining tool (20) is placed into the two liner components across the contact portions thereof, and the probe (22) in rotation is thereafter moved relative to the two liner components (4, 5). Assuming that the number of revolutions of the probe (22) is R rpm and that the speed of joining of the two liner components (4, 5) is V mm/min, R/V is in the range of 2≦R/V≦12.

### CROSS REFERENCE TO RELATED APPLICATION

This application is an application filed under 35 U.S.C. §111(a) claiming the benefit pursuant to 35 U.S.C. §119(e)(1) of the filing date of Provisional Application No. 60/561,534 filed Apr. 13, 2004 pursuant to 35 U.S.C. §111(b).

### TECHNICAL FIELD

The present invention relates to liners for use in pressure vessels for storing hydrogen gas or natural gas serving as a fuel for power generation, or for use in pressure vessels for storing oxygen gas, for example, in the automobile industry, housing industry, military industry, aerospace industry, medical industry, etc. and to a process for producing the liner.

The term “aluminum” as used herein and in the appended claims includes aluminum alloys in addition to pure aluminum.

### BACKGROUND ART

In order to control air pollution, efforts have been made in recent years for developing natural gas motor vehicles and fuel cell motor vehicles which produce clean emissions. These motor vehicles have installed therein a pressure vessel containing fuel natural gas or hydrogen gas to a high pressure, and it is desired to fill the vessel with the gas to a further higher pressure for driving over increased distances.

Liners are already known for use in such high pressure vessels. The known liner comprises a tubular trunk and a pair of head plates for closing opposite end openings of the trunk. The liner comprises a first liner component made of an aluminum extrudate and having a cylindrical peripheral wall and opposite open ends for providing the trunk, and two second liner components made from aluminum by die casting, each having a dome-shaped peripheral wall and welded respectively to opposite ends of the first component by melting for providing the head plates (see the publication of JP-A No. 9-42595).

For use as a high pressure vessel, the liner disclosed in the publication has a helical winding reinforcing layer formed by winding reinforcing fibers around the trunk longitudinally thereof and partly around the two second components to obtain a helically wound fiber layer, impregnating the fiber layer with an epoxy resin and curing the resin, and a hooped reinforcing layer made by winding reinforcing fibers around the trunk circumferentially thereof to form a hooped fiber layer, impregnating the fiber layer with an epoxy resin and curing the resin.

With the pressure vessel liner disclosed in the publication, the first liner component is welded to the second liner components by melting, so that the welded joints are insufficient in strength. In the case where the liner is subjected to a great force longitudinally thereof, stress acts concentrically on the welded joint of the first component and the second component, possibly fracturing the liner at the joint portion. To prevent such a fracture, there is a need to give an increased thickness to the helical winding reinforcing layer of the high pressure vessel. Consequently the vessel has the problem of becoming greater in weight. Further in forming the helically wound fiber layer, fibers are likely to become broken by sliding contact or by being caught, entailing the likelihood that the required pressure resistance will not be available.

A liner is also known which is increased in the strength of the joint between the two liner components for use in high pressure vessels. This liner comprises a tubular trunk and a pair of head plates for closing opposite end openings of the trunk. More specifically, the liner comprises a first liner component made of aluminum and having a cylindrical peripheral wall and opposite open ends for providing the trunk, two second liner components made of aluminum, each having a dome-shaped peripheral wall and joined respectively to opposite ends of the first component for providing the head plates, and a structural support member in the form of a wagon wheel and provided inside the peripheral wall of the first component and the peripheral wall of each second component so as to be positioned over the joint of the two components, the first and second components and the support member being joined by friction agitation (see the publication of JP-A No. 10-160097).

With the liner disclosed in this publication, the first liner component and the second liner component are joined by friction agitation, so that the joint between the components has a greater strength than in the pressure vessel liner disclosed in the publication of JP-A No. 9-42595.

However, the publication of JP-A No. 10-160097 fails to disclose the optimum conditions for joining the liner components to each other by friction agitation in fabricating the liner. It is likely that an internal defect will occur in the joint to result in an impaired joint strength, or the probe will become broken to result in lower productivity.

An object of the present invention is to overcome the forgoing problems and provide a process for fabricating a pressure vessel liner which is prevented from becoming reduced in the strength of the joint between the liner components and which is available with high productivity without impairment.

### DISCLOSURE OF THE INVENTION

We have conducted extensive research and accomplished the present invention based on the finding that the relationship between the number of revolutions of the probe for use in friction agitation joining and the joining speed exerts a great influence on the improvement of quality of the joint between the two liner components of the pressure vessel liner to be produced. The invention comprises the following modes.

1) A process for fabricating a pressure vessel liner comprising a tubular trunk and two head plates for closing opposite end openings of the trunk by joining at least two liner components so shaped as to resemble the liner as divided into segments longitudinally thereof, the process including bringing two adjacent liner components into contact with each other, placing a probe of a friction agitation joining tool into the two liner components across the contact portions thereof, thereafter moving the probe relative to the two liner components while rotating the probe to thereby move the probe along the contact portions over the entire circumference thereof and join the two liner components to each other by friction agitation, the process being characterized in that assuming that the number of revolutions of the probe is R rpm and that the speed of joining of the two liner components is V mm/min, R/V is in the range of 2≦R/V≦12.

If R/V is less than 2 in the process described in par. 1), an insufficient heat input produces internal defects in the joint, rendering the pressure vessel liner to be fabricated insufficient in the strength of the joint while causing a break in the probe or shortening the life of the probe. If the ratio is greater than 12, an excess of heat input produces surface roughness or surface faults in the pressure vessel liner to be produced. Accordingly, the value R/V should be in the range of 2 to 12.

2) A process for fabricating a pressure vessel liner according to par. 1) wherein R/V is in the range of 2≦R/V≦8.

3) A process for fabricating a pressure vessel liner according to par. 1) wherein the contact portions of the two liner components are 0.5 to 20 mm in wall thickness.

If the wall thickness is less than 0.5 mm in the process according to par. 3), the liner components are like to deform, causing separation of a material layer during joining, so that there arises a need to use a jig for fixing the liner components or to make the overall apparatus complex in construction to prevent such trouble. If the thickness is in excess of 20 mm, there arises a need to increase the probe length and probe diameter, consequently necessitating a large-sized apparatus capable of withstanding the load to be applied by the probe during joining. In either case, the apparatus become costly therefore.

4) A process for fabricating a pressure vessel liner according to par. 1) wherein the contact portions of the two liner components are joined by friction agitation through at least 360 degrees circumferentially thereof.

5) A process for fabricating a pressure vessel liner according to par. 1) wherein all the liner components are made of aluminum.

6) A process for fabricating a pressure vessel liner according to par. 1) which comprises preparing a first liner component having a tubular peripheral wall having opposite end openings for providing the trunk and two second liner components each having a dome-shaped peripheral wall for providing the respective head plates, and joining the peripheral walls of the first liner component and the second liner components by friction agitation.

7) A process for fabricating a pressure vessel liner according to par. 6) wherein the first liner component is made from aluminum by extrusion, and the second liner components are made from aluminum by forging.

8) A pressure vessel liner fabricated by a process according to any one of pars. 1) to 7).

9) A pressure vessel comprising a pressure vessel liner according to par. 8) and a fiber reinforced resin layer covering an outer peripheral surface of the liner.

10) A pressure vessel according to par. 9) wherein the fiber reinforced resin layer comprises a helically wound fiber layer formed by winding a reinforcing fiber around the trunk longitudinally thereof and partly around the head plates, a hoped fiber layer made by winding a reinforcing fiber around the trunk circumferentially thereof and a resin impregnating the fibers layers and cured.

11) A fuel cell system comprising a fuel hydrogen pressure vessel, a fuel cell and pressure piping for sending fuel hydrogen gas from the pressure vessel to the fuel cell therethrough, the fuel hydrogen pressure vessel comprising a pressure vessel according to par. 9).

12) A fuel cell motor vehicle having installed therein a fuel cell system according to par. 11).

13) A cogeneration system comprising a fuel cell system according to par. 11).

14) A natural gas supply system comprising a natural gas pressure vessel and pressure piping for sending out natural gas from the pressure vessel therethrough, the natural gas pressure vessel comprising a pressure vessel according to par. 9).

15) A cogeneration system comprising a natural gas supply system according to par. 14), a generator and a generator derive device.

16) A natural gas motor vehicle comprising a natural gas supply system according to par. 14) and an engine for use with natural gas as a fuel.

17) An oxygen gas supply system comprising an oxygen pressure vessel and pressure piping for sending out oxygen gas from the pressure vessel therethrough, the oxygen pressure vessel comprising a pressure vessel according to par. 9).

In the pressure liner fabrication process according to par. 1), it is assumed that the number of revolutions of the probe is R rpm and that the speed of joining of the two liner components is V mm/min. R/V is then in the range of 2≦R/V≦12. Accordingly, it is unlikely that the heat input will be excessive or insufficient, with the result that the joint between the liner components is prevented from developing internal defects and from becoming impaired in strength. Consequently, the joint in the pressure vessel liner to be produced is satisfactory in pressure resistance in the longitudinal direction of the trunk. Furthermore, it becomes possible to preclude the probe from breaking or becoming shortened in life to result in improved productivity. Additionally, the pressure vessel liner to be fabricated can be free from surface roughness or prevented from developing surface defects.

The pressure liner fabrication process according to par. 2) assures the advantages of the process described in par. 1) more remarkably.

With the pressure liner fabrication process according to par. 3), the liner components can be prevented from deforming when the probe is placed thereinto. This eliminates the need to use a jig for fixing the liner components or to make the entire apparatus complex in construction, and renders the load to be applied by the probe during joining relatively small to obviate the need to use a large-sized apparatus, consequently entailing a reduced apparatus cost.

The pressure liner fabrication process according to par. 4) further improves the joint in pressure resistance and gas tightness.

The pressure liner fabrication process according to par. 5) provides a pressure vessel liner of reduced weight.

With the pressure liner fabrication process according to par. 6), the first liner component can be given a desired length. This makes it possible to suitably alter the length of the pressure vessel liner to be fabricated in accordance with the required capacity. In the case of a liner component which has a peripheral wall comprising a tubular portion and a dome-shaped portion integral therewith, that is, in the case of a liner component having at least a portion of trunk and a head plate closing one end opening of the trunk, the liner component must be made by forging, whereas increasing the length of the trunk requires very difficult fabrication work.

The first liner component and the second liner components can be produced relatively easily by the pressure liner fabrication process according to par. 7).

### BRIEF DESCRIPTION OF THE DRAWINGS

FIG. 1 is a perspective view showing a pressure vessel liner fabricated by a process of the invention.

FIG. 2 is a view in longitudinal section of a high pressure vessel wherein the liner of FIG. 1 is used.

FIG. 3 is a perspective view showing the process for fabricating the liner of FIG. 1.

FIG. 4 is an enlarged fragmentary view similarly showing the process for fabricating the liner of FIG. 1.

FIG. 5 includes enlarged fragmentary views showing modified liner components.

FIG. 6 is a graph showing the results of a specific example.

### BEST MODE OF CARRYING OUT THE INVENTION

An embodiment of the invention will be described below with reference to the drawings.

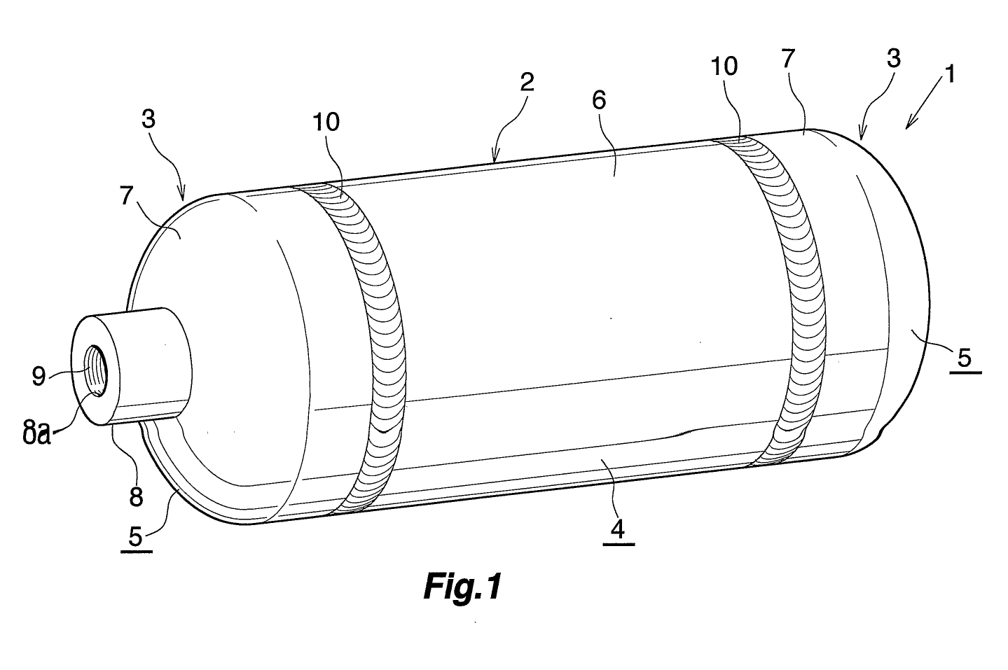

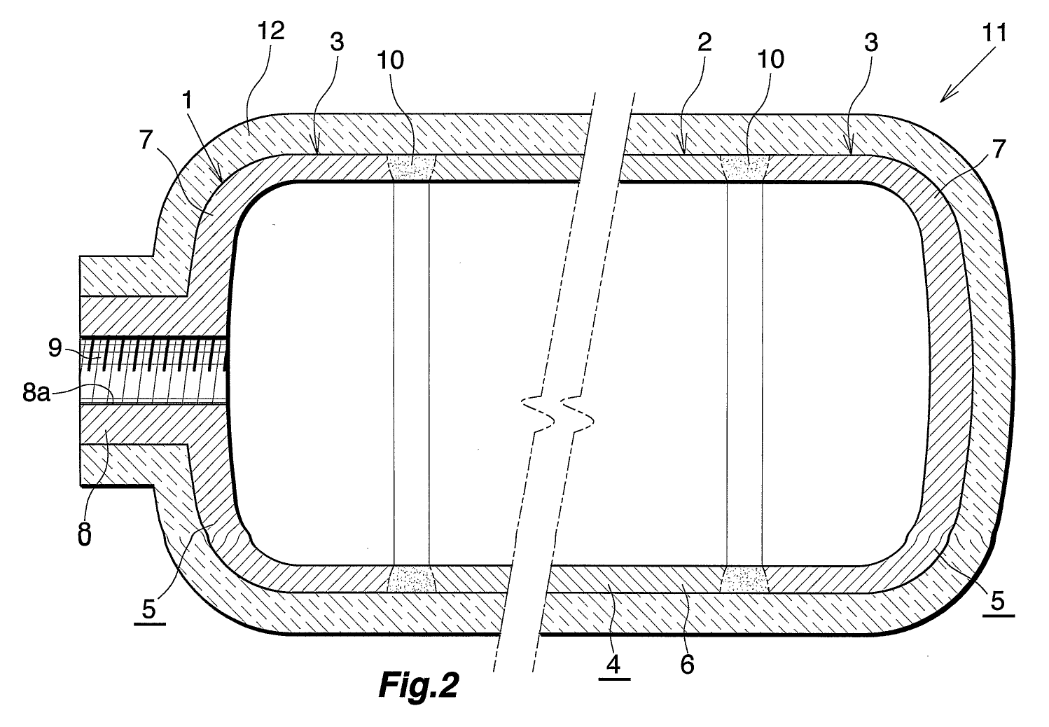

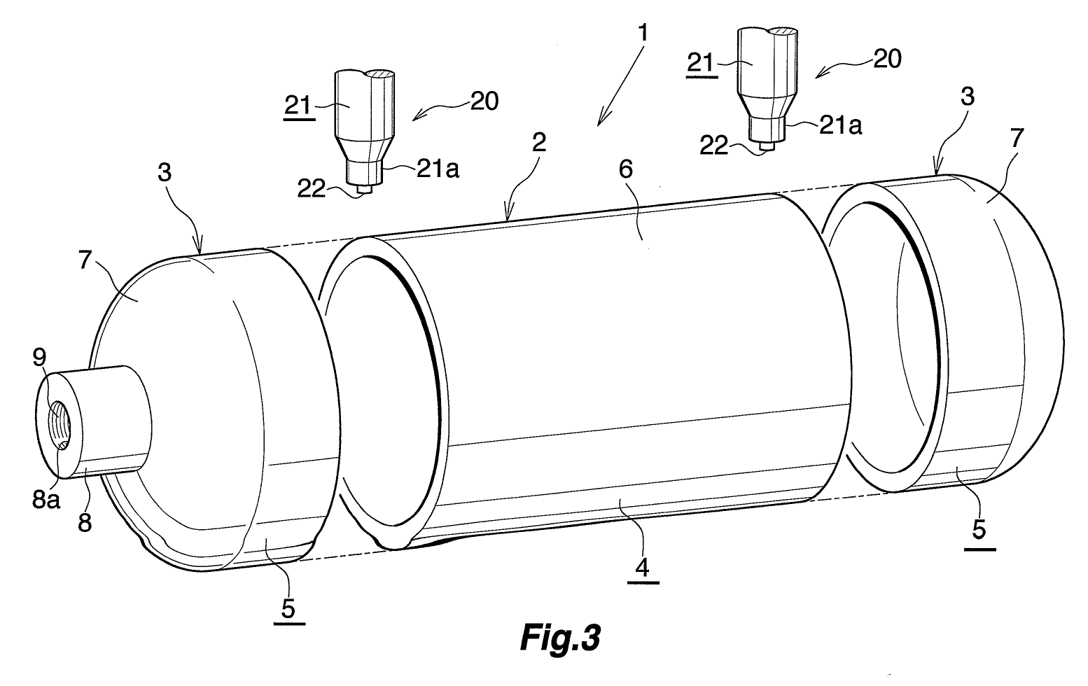

FIG. 1 shows the overall construction of a pressure vessel liner fabricated by a production process of the invention, and FIG. 2 is a high-pressure hydrogen gas vessel wherein the liner of FIG. 1 is used. FIGS. 3 and 4 show the process for fabricating the liner.

With reference to FIG. 1, the pressure vessel liner 1 comprises a hollow cylindrical trunk 2, and head plates 3 for closing openings at opposite ends thereof. More specifically, the liner 1 comprises a first liner component 4 made of an aluminum extrudate tube having an openings at each of opposite ends thereof and providing the trunk 2, and two second liner components 5 of aluminum joined to the respective opposite ends of the first component 4 and providing the head plates 3. The second liner components 5 are made by forging or cutting.

The first liner component 4 has a peripheral wall 6 having a circular cross section and providing the trunk 2. Each of the second liner components 5 has a dome-shaped peripheral wall 7 open at one end thereof and providing the head plate 3. The open end of the peripheral wall 7 is circular. One of the second liner components 5 is integrally provided with a mouthpiece mount portion 8. This portion 8 has a through bore 8a extending therethrough from the outer end thereof and is internally threaded as at 9.

The first component 4 and the second components 5 are each made, for example, from any one of JIS A2000 alloy, JIS A5000 alloy, JIS A6000 alloy and JIS A7000 alloy. These components 4, 5 may be made from the same material, or at least two of these three components may be made from different materials.

Each end of the peripheral wall 6 of the first liner component 4 and the open end of each second liner component 5 are in contact with each other, and the liner components are joined at the contact portions thereof by friction agitation over the entire circumference. The beads of the resulting joint are indicated at 10.

As shown in FIG. 2, the pressure vessel liner 1 is entirely covered with a fiber reinforced resin layer 12 comprising, for example, a carbon fiber reinforced resin for use as a high pressure vessel 11. The fiber reinforced resin layer 12 comprises a helical winding reinforcing layer formed by winding reinforcing fibers around the trunk 2 longitudinally thereof and partly around the two head plates 3, a hoped reinforcing layer made by winding reinforcing fibers around the trunk 2 circumferentially thereof, and a resin impregnating these reinforcing layers and cured as in the case of the pressure vessel liner disclosed in JP-A No. 9-42595. The resin to be used is a thermosetting resin or photosetting resin.

The high pressure vessel is used in fuel cell systems comprising a fuel hydrogen pressure vessel, fuel cell and pressure piping for sending fuel hydrogen gas from the pressure vessel to the fuel cell therethrough, as the fuel hydrogen pressure vessel. The fuel cell system is installed in a fuel cell motor vehicle. The fuel cell system is used also in cogeneration systems.

The high pressure vessel is used also in natural gas supply systems comprising a natural gas pressure vessel and pressure piping for sending out natural gas from the pressure vessel therethrough, as the natural gas pressure vessel. The natural gas system is used in cogeneration systems along with a generator and a generator drive device. The natural gas supply system is used also in natural gas motor vehicle comprising an engine for use with natural gas.

The high pressure vessel is used further in oxygen gas supply systems comprising an oxygen pressure vessel and pressure piping for sending out oxygen gas from the pressure vessel therethrough, as the oxygen pressure vessel.

The pressure vessel liner 1 is fabricated by the process to be described below with reference to FIGS. 3 and 4.

First, a first liner component 4 is made by extrusion, and two second liner components 5 are made by forging or cutting. Then formed in a mouthpiece mount portion 8 of the second liner component 5 having this portion is a bore 8a extending through this portion 8 from the outer end thereof, and the mount portion 8 is internally threaded as indicated at 9.

The open end of the peripheral wall 7 of one of the second liner component 5 is subsequently brought into contact with one end face of the peripheral wall 6 of the first liner component 4 (see FIG. 4), and the peripheral walls 6, 7 of the two components 4, 5 are joined by friction agitation at the portions thereof in contact, using a friction agitation joining tool 20.

The peripheral wall 6 of the first liner component 4 and the peripheral wall 7 of the second liner component 5 have a wall thickness of 0.5 to 20 mm and are equal in wall thickness, at the portions thereof in contact with each other.

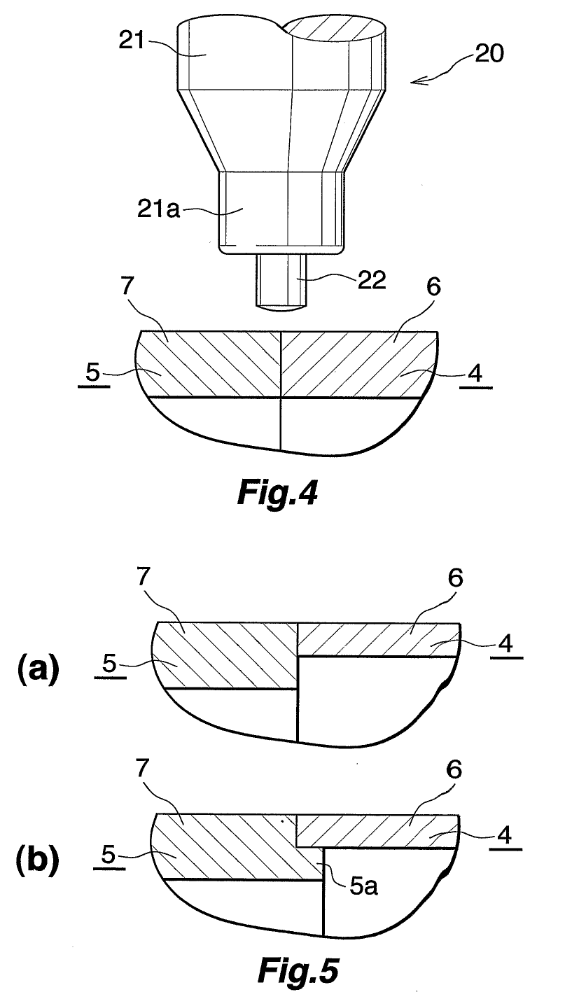

As shown in FIG. 5(a), the contact portion of peripheral wall of one of the liner components may be made greater than the contact portion of peripheral wall of the other liner component in wall thickness, and the peripheral walls of the two liner components may be brought into contact with each other so that the outer surfaces of the contact portions will be positioned on the same cylindrical surface. In the illustrated modification, the contact portion of peripheral wall 7 of the second liner component 5 is greater than the contact portion of peripheral wall 6 of the first liner component 4 in wall thickness. Further as shown in FIG. 5(b), the end portion of peripheral wall of the liner component having the greater wall thickness, i.e., of the peripheral wall 7 of the second liner component 5, which end portion projects inward beyond the inner surface of peripheral wall of the liner component having the smaller wall thickness, i.e., of the peripheral wall 6 of the first liner component 4 may be integrally provided with a part 5a for supporting the peripheral wall 6 of the first liner component. Even in the case where the contact portions of peripheral walls 6, 7 of the two liner components 4, 5 are different in wall thickness as shown in FIG. 5, it is desired that the above wall thickness of the liner components 4, 5 be 0.5 to 20 mm.

The friction agitation joining tool 20 comprises a solid cylindrical rotor 21 having a small-diameter portion 21a provided integrally therewith at a forward end thereof and extending from the rotor axially thereof with a tapered portion provided therebetween, and a pinlike probe 22 extending from the end of the rotor small-diameter portion 21a axially thereof and integrally therewith and having a smaller diameter than the portion 21a. The rotor 21 and the probe 22 are made of a material harder than the liner components 4, 5 and having heat resistance to withstand the frictional heat to be produced during joining.

Subsequently, while the rotor 21 and the probe 22 of the friction agitation joining tool 20 are held in rotation, the probe 22 is placed from outside into the portions of the peripheral walls 6, 7 of the first and second liner component 4, 5 in contact with each other at a position along the circumferential direction, with the shoulder of the small-diameter portion 21a of the tool 20 around the probe 22 pressed against the peripheral walls 6, 7. Although the material of a softened portion is likely to scatter at the start of and during joining, the pressing contact of the shoulder of the small-diameter portion 21a with the peripheral walls produces a satisfactory joint by preventing such trouble at this time, further generating frictional heat by the sliding movement of the shoulder on the walls 6, 7 and softening the portions of the walls 6, 7 in contact with the probe 22 and the vicinity thereof to a greater extent while preventing formation of flashes or like irregularities on the surface of the joint.

The friction agitation joining tool 20 is then moved relative to the first and second liner components 4, 5 while rotating the rotor 21 and the probe 22 to move the probe 22 along the contact portions circumferentially thereof. The frictional heat generated by the rotation of the probe 22 and the frictional heat generated by the sliding movement of the shoulder on the peripheral walls 6, 7 soften the base material metal of the walls 6, 7 in the vicinity of the contact portions thereof, and the softened portion is agitated and mixed by being subjected to the rotational force of the probe 22, further plastically flows to fill up a groove left by the passage of the probe 22 and thereafter rapidly loses the frictional heat to solidify on cooling. These phenomena are repeated with the movement of the probe 22 to join the peripheral walls 6, 7 to each other. When the friction agitation joining tool 20 is moved relative to the first and second liner components 4, 5, it is assumed that the number of revolutions of the probe 22 is R rpm, and that the speed of movement of the friction agitation joining tool 20 relative to the first and second liner components 4, 5, i.e., the speed of joining of the peripheral walls 6, 7 to each other, is V mm/min. The number of revolutions of the probe 22 and the joining speed are so adjusted that 2≦R/V≦12, preferably 2≦R/V≦8.

Upon the return of the probe 22 to the initial position where it is first placed into the walls to be joined after moving along the contact portions over the entire circumference, the two peripheral walls 6, 7 are joined over the entire circumference. Beads 10 are formed at this time. After the probe 22 is returned to the initial position, preferably after the probe 22 is moved past this position, the probe 22 is moved to the location of a contact member (not shown) disposed at the contact portions of the peripheral walls 6, 7, where the probe 22 is withdrawn from the resulting assembly. The peripheral walls of the liner components 4, 5 are joined to each other at the contact portions thereof preferably through at least 360 degrees along the circumferential direction In the same manner as above, the other second liner component 5 is also joined to the first liner component 4 by friction agitation. In this way, the pressure vessel liner 1 is fabricated.

In the above embodiment, the peripheral wall 6 of the first liner component 4 may be integrally provided with reinforcing walls extending longitudinally of the wall 6 and dividing the interior of the wall 6 into a plurality of spaces, with the peripheral wall 7 of the second liner component 5 integrally provided with reinforcing walls positioned in corresponding relation with the respective reinforcing walls of the first liner component 4.

According to the foregoing embodiment, the pressure vessel liner 1 comprises a first liner component 4 and two second liner components 5, whereas these components are not limitative; one of the head plates 3 may be made integral with the trunk 2. The first component to be used then comprises a bottomed tubular body having an open end and a closed end and providing the trunk 2 and one head plate 3. In this case, a second liner component providing the other head plate 3 is joined to the open end of the first component. In the case where the second component to be used has no mouthpiece mount portion, the head plate 3 of the first component has a mouthpiece mount portion integral therewith. The first component in the form of a bottomed tubular body is made, for example, by forcing. Further alternatively, the first component may comprise a plurality of divided liner components to be arranged longitudinally thereof.

In the foregoing embodiment, the trunk 2, i.e., the peripheral wall 6 of the first liner component 4, is circular in cross section, whereas this structure is not limitative. The component may have a suitable shape, for example, an elliptical cress section. The head plate 3, i.e., the second liner component 5, is then altered in shape in conformity with the shape of the first component.

A specific example of the invention is given below along with a comparative example.

Plate test pieces were prepared which were made from JIS A6061-T6 and had a thickness of 5 mm. Also prepared was a friction agitation joining tool 20 having a rotor and a probe 22 which were made from JIS SKD61, the probe having a diameter of 5 mm.

While the rotor 21 and the probe 22 of the friction agitation joining tool 20 were held in rotation with two test pieces brought into contact with each other along one side edge of each, the probe 22 was subsequently placed into the contact portions of the test pieces at one end of the arrangement, and the shoulder of the small-diameter portion of the tool 20 around the probe 22 was pressed against the test pieces. The joining tool 20 was then moved relative to the test pieces while rotating the rotor 21 and the probe 22 to move the probe 22 straight along the contact portions and join the two test pieces to each other. This testing procedure was repeated with the number of revolutions R rpm and the joining speed V mm/min altered variously.

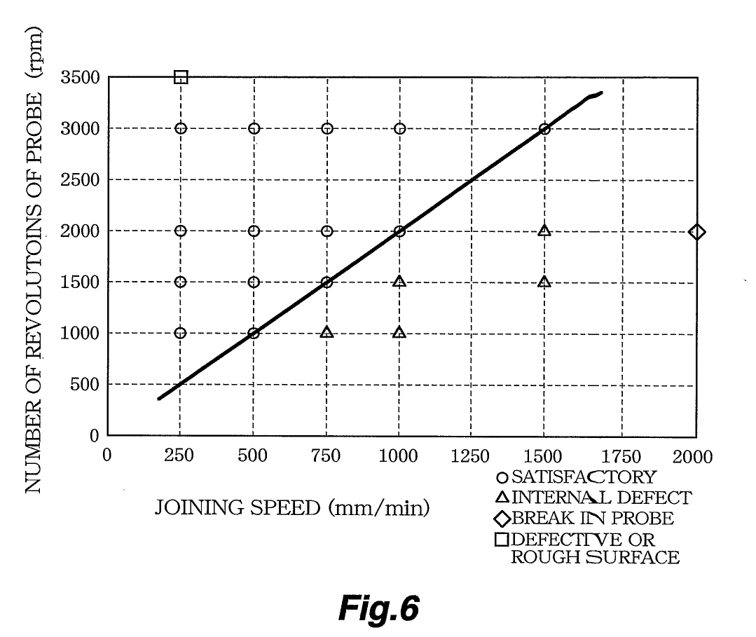

The joint of each of the pairs of test pieces was checked for the state of the surface thereof. The joint was cut to check the state of the interior thereof, and the probe 22 was also checked. FIG. 6 shows the results. With reference to FIG. 6, the mark ◯ indicates that the interior of the joint is in a satisfactory state, the mark Δ indicates that the joint had an internal defect, and the mark ⋄ indicates that the probe 22 was broken, and the mark □ indicates that the joint had a rough surface. FIG. 6 reveals that the joint develops an internal defect or the probe 22 breaks when the value R/V is less than 2 (the area below the straight line in FIG. 6), and that the joint of the test pieces has a defective or rough surface when the value R/V is greater than 12.

### INDUSTRIAL APPLICABILITY

The liner of the invention is suited to use in pressure vessels for storing hydrogen gas or natural gas serving as a fuel for power generation, or for use in pressure vessels for storing oxygen gas, for example, in the automobile industry, housing industry, military industry, aerospace industry, medical industry, etc.

1: A process for fabricating a pressure vessel liner comprising a tubular trunk and two head plates for closing opposite end openings of the trunk by joining at least two liner components so shaped as to resemble the liner as divided into segments longitudinally thereof, the process including bringing two adjacent liner components into contact with each other, placing a probe of a friction agitation joining tool into the two liner components across the contact portions thereof, thereafter moving the probe relative to the two liner components while rotating the probe to thereby move the probe along the contact portions over the entire circumference thereof and join the two liner components to each other by friction agitation,
the process being characterized in that assuming that the number of revolutions of the probe is R rpm and that the speed of joining of the two liner components is V mm/min, R/V is in the range of 2≦R/V≦12.

2: A process for fabricating a pressure vessel liner according to claim 1 wherein R/V is in the range of 2≦R/V≦8.

3: A process for fabricating a pressure vessel liner according to claim 1 wherein the contact portions of the two liner components are 0.5 to 20 mm in wall thickness.

4: A process for fabricating a pressure vessel liner according to claim 1 wherein the contact portions of the two liner components are joined by friction agitation through at least 360 degrees circumferentially thereof.

5: A process for fabricating a pressure vessel liner according to claim 1 wherein all the liner components are made of aluminum.

6: A process for fabricating a pressure vessel liner according to claim 1 which comprises preparing a first liner component having a tubular peripheral wall having opposite end openings for providing the trunk and two second liner components each having a dome-shaped peripheral wall for providing the respective head plates, and joining the peripheral walls of the first liner component and the second liner components by friction agitation.

7: A process for fabricating a pressure vessel liner according to claim 6 wherein the first liner component is made from aluminum by extrusion, and the second liner components are made from aluminum by forging.

8: A pressure vessel liner fabricated by a process according to claim 1.

9: A pressure vessel comprising a pressure vessel liner according to claim 8 and a fiber reinforced resin layer covering an outer peripheral surface of the liner.

10: A pressure vessel according to claim 9 wherein the fiber reinforced resin layer comprises a helically wound fiber layer formed by winding a reinforcing fiber around the trunk longitudinally thereof and partly around the head plates, a hoped fiber layer made by winding a reinforcing fiber around the trunk circumferentially thereof and a resin impregnating the fibers layers and cured.

11: A fuel cell system comprising a fuel hydrogen pressure vessel, a fuel cell and pressure piping for sending fuel hydrogen gas from the pressure vessel to the fuel cell therethrough, the fuel hydrogen pressure vessel comprising a pressure vessel according to claim 9.

12: A fuel cell motor vehicle having installed therein a fuel cell system according to claim 11.

13: A cogeneration system comprising a fuel cell system according to claim 11.

14: A natural gas supply system comprising a natural gas pressure vessel and pressure piping for sending out natural gas from the pressure vessel therethrough, the natural gas pressure vessel comprising a pressure vessel according to claim 9.

15: A cogeneration system comprising a natural gas supply system according to claim 14, a generator and a generator derive device.

16: A natural gas motor vehicle comprising a natural gas supply system according to claim 14 and an engine for use with natural gas as a fuel.

17: An oxygen gas supply system comprising an oxygen pressure vessel and pressure piping for sending out oxygen gas from the pressure vessel therethrough, the oxygen pressure vessel comprising a pressure vessel according to claim 9.
